(19) United States
(12) Patent Application Publication
(10) Pub. No.: US 2015/0300395 A1
(43) Pub. Date: Oct. 22, 2015

(54) Windshield and Fairing Replacement Insert Installation Tool

(71) Applicant: Michael A. Laurenzo, Chatsworth, GA (US)

(72) Inventor: Michael A. Laurenzo, Chatsworth, GA (US)

(21) Appl. No.: 14/688,300

(22) Filed: Apr. 16, 2015

Related U.S. Application Data
(60) Provisional application No. 61/980,189, filed on Apr. 16, 2014.

(51) Int. Cl. F16B 35/00

(52) U.S. Cl. CPC F16B 35/00

(57) ABSTRACT

A windshield and fairing replacement insert installation tool includes a bolt fastening member, a spacer sleeve, and a knurled thumb nut. The spacer sleeve is rotatably encircled around a shank section of the bolt fastening member while the knurled thumb nut is threadly engaged with a threaded section of the bolt fastening member. The threaded section partially extends below the knurled thumb nut so that the extended portion of the threaded section is able to accept a replacement insert that needs to be placed within the opening of the fairing. The installation tool is then able to firmly and securely drive in the replacement insert into the opening of the fairing without damaging the replacement insert as the spacer sleeve and the knurled thumb nut assist the installation process.

The current application claims a priority to the U.S. Provisional Patent application Ser. No. 61/980,189 filed on Apr. 16, 2014.

### FIELD OF THE INVENTION

The present invention relates generally to a tool for use on vehicles. More specifically, the present invention is an installation tool used for installing replacement brass insert that engages with a screw or bolt.

### BACKGROUND OF THE INVENTION

The existing captive nuts that are pressed or molded into the fairing on a motorcycle are utilized to secure other connecting fairing or windshield as the existing captive nuts are pre-manufactured. However, the pre-manufactured captive nuts become loose, spin, or fall out from the fairing overtime due over tighten of the screws that goes into the captive nuts. A lot of people do not have the touch or feel for tightening down screws or bolts correctly causing the captive nuts to be inefficient. For example, the original brass inserts that comes from the Harley Davidson factory are pressed or molded into the fairing when the fairing is made, where the brass inserts secures the windshield to the fairing. Over a small amount of time, the brass inserts come loose and spin or just fall out as it does not take very much to over tighten the screws that go into the brass inserts. When the bolts are not held correctly, the windshield starts to vibrate and the brass inserts become looser and looser. Then the windshield pulls out the brass inserts separating the windshield from the inner and outer fairing. There are a total of seven brass inserts on the fairing. Three of which hold the windshield in place tight and four others that hold the fairing together on a touring bike as the brass inserts can be replaced with threaded replacement inserts when they become inefficient. The replacement insert part number for the brass inserts of Harley Davidson is #16585-96.

Normally, a screw and two nuts are utilized to drive in the replacement inserts. One would use a wrench to tap the replacement insert into the opening on the fairing of the motorcycle. Thusly, the users do not have great control to tap the replacement insert in straight and could not apply even pressure when tapping the self-tapping replacement insert in. Once the replacement insert is in place, the user then uses two different tools to break the two nuts loose in order to back out the bolt from the replacement insert itself. The present invention is easier to control when tapping the opening with the replacement insert. No other tool or wrenches are needed as the present invention is all self-contained. Once the replacement insert is fully flush with the opening, the present invention can be removed by grasping a knurled thumb nut at the base of the installation tool with one hand, and a slight twist of a bolt fastening member to break the present invention loose from the replacement insert.

### BRIEF DESCRIPTION OF THE DRAWINGS

FIG. 1 is a top perspective view of the present invention.

FIG. 2 is a bottom perspective view of the present invention.

FIG. 3 is a perspective exploded view of the present invention.

FIG. 4 is a side exploded view of the present invention.

FIG. 5 is a front view of the present invention, showing the plane upon which a cross sectional view is taken shown in FIG. 6.

FIG. 6 is a cross section view the present invention taken along line A-A of FIG. 5.

### DETAIL DESCRIPTIONS OF THE INVENTION

All illustrations of the drawings are for the purpose of describing selected versions of the present invention and are not intended to limit the scope of the present invention.

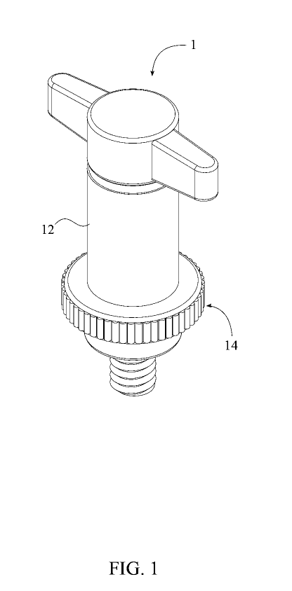

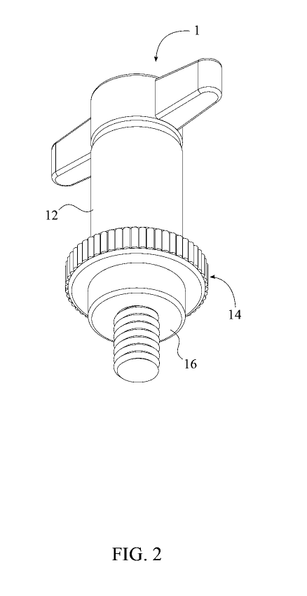

The present invention is an installation tool that is used for installing replacement brass inserts for existing captive nuts. More specifically, the existing captive nuts are normally pressed or molded into the fairings of a motorcycle so that the windshield or other connecting fairings can be attached with the captive nuts. Overtime, the captive nuts come loose, spin, or fall out mainly due to the over-tightening of the screws. The present invention provides a solution for the above problem as the present invention allows the user to efficiently install the replacement inserts for the captive nuts so that the windshield and other connecting fairings can be securely reattached to the motorcycle. In reference to FIG. 1-2, the present invention comprises a bolt fastening member 1, a spacer sleeve 12, and a knurled thumb nut 14 as the configuration of the above components forms the present invention.

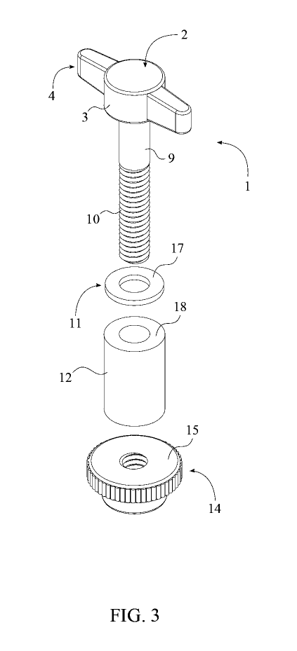

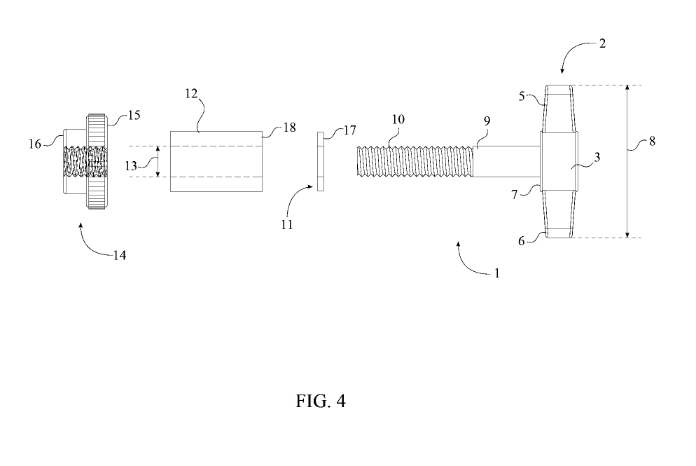

The bolt fastening member 1 allows the user to secure the replacement insert onto the present invention and drives in the replacement insert into the fairing. The bolt fastening member 1 also functions as the main component of the present invention as the remaining components are attached to the bolt fastening member 1. In reference to FIG. 3-4, the bolt fastening member 1 comprises a head section 2, a shank section 9, and a threaded section 10. More specifically, the shank section 9 is concentrically positioned with the head section 2 while the threaded section 10 is concentrically positioned with the shank section 9, opposite of the head section 2.

The head section 2, which allows torque to be applied through a mating tool or by hand, enables the user to twist the bolt fastening member 1 within the present invention. In the preferred embodiment of the present invention as shown in FIG. 3-4, the head section 2 comprises a hub section 3, at least one pair of handles 4, and a flat bottom surface 7. The hub section 3 functions as the interconnecting component between the shank section 9 and the at least one pair of handles 4 so that the at least one pair of handles 4 can be radially extended from the hub section 3. The at least one pair of handles 4 comprises a first arm 5 and a second arm 6, where the first arm 5 and the second arm 6 are diametrically opposed of each other about the hub section 3 in order to provide maximum gripping area for the user. Even though the preferred embodiment of the present invention utilizes the least one pair of handles 4 within the head section 2, the present invention can also function without the least one pair of handles 4 if the head section 2 of the present invention may include any other type of torque applying configuration such as, any types of screw driver heads and any types of socket heads.

The spacer sleeve 12, which provides the correct length for the present invention to work with the fairings, comprises an inner lateral surface and an outer lateral surface as the inner lateral surface and the outer lateral surface are extended along the spacer sleeve 12. In reference to FIG. 3-6, the spacer sleeve 12 is rotatably encircled around the shank section 9 in such a way that the inner lateral surface is adjacently positioned with the shank section 9. An outer diameter 8 of the head section 2 is larger than an inner diameter 13 of the spacer sleeve 12 so that the spacer sleeve 12 is able to retain with the bolt fastening member 1, adjacent to the head section 2. Additionally, the preferred embodiment of the present invention comprises a flat washer 11 so that the spacer sleeve 12 is easily able to rotate around the shank section 9. More specifically, the flat washer 11 is concentrically positioned around the shank section 9 as the flat washer 11 is rotatably positioned in between the spacer sleeve 12 and the head section 2. As a result, a top washer-surface 17 of the flat washer 11 and a top sleeve-surface 18 the spacer sleeve 12 are able to position parallel with the flat bottom surface 7 creating a level configuration between the connecting components.

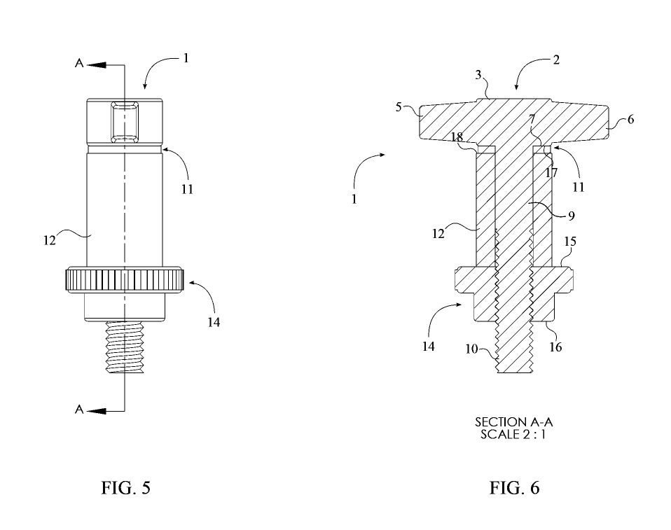

The knurled thumb nut 14, which retains the spacer sleeve 12 within the bolt fastening member 1 opposite of the head section 2, is threadly engaged with the threaded section 10. In reference to FIG. 5-6, the knurled thumb nut 14 is concentrically positioned around the threaded section 10 and positioned adjacent to the spacer sleeve 12. The knurled thumb nut 14 is engaged in such a way that the spacer sleeve 12 is adjacently positioned with a top surface 15 of the knurled thumb nut 14 while the threaded section 10 partially extends from a bottom surface 16 of the knurled thumb nut 14 as an attachment portion within the present invention. Preferably, an outer diameter of the spacer sleeve 12 is smaller than an outer diameter of the knurled thumb nut 14 so that the knurled thumb nut 14 can be easily reached by the user to perform necessary adjustment to the present invention as the knurled thumb nut 14 extends beyond the spacer sleeve 12.

In reference to the installation process of the replacement insert, the attachment portion of the present invention first accepts the replacement insert so that the replacement insert can be secured to the present invention. More specifically, the setup of the present invention allows the user to screw the replacement insert onto the attachment portion with a slotted side of the replacement insert facing outward until all moving components are snug (touching but not tight).

Then the knurled thumb nut 14 is grasped with one hand and the head section 2 with the other hand. The user then twists the head section 2 in the counterclockwise direction, as to loosen the bolt fastening member 1 from the knurled thumb nut 14. However, the counterclockwise twisting of the head section 2 actually tightens the replacement insert to the bottom surface 16 of the knurled thumb nut 14. Then the spacer sleeve 12 is able to spin or move freely apart from the rest of the components of the present invention.

The present invention is then twisted in the clockwise direction so that the replacement insert can be driven into the fairing. The replacement insert is threaded into the opening, the hole created by the removal of the captive nut, until the bottom surface 16 of knurled thumb nut 14 is flushed with the opening holding the replacement insert. Occasionally, reverse threading action is required to break material within the fairing so that the replacement insert can be threaded flush with the fairing. However, if the replacement insert can be easily threaded into the opening, reverse threading might not be needed.

Then the knurled thumb nut 14 is grasped from one hand and twist the bolt fastening member 1 from the other hand slightly in the counterclockwise direction. As a result, the bolt fastening member 1 is loosened from the replacement insert while the replacement insert is secured within the opening. The rotatability in the spacer sleeve 12 is needed within the present invention as the user loosens the bolt fastening member 1 from the replacement insert once the replacement insert is threaded into the opening. Then the bolt fastening member 1 is completely removed from the replacement insert, leaving the replacement insert flush with the opening and the fairing.

The slotted side of the replacement insert faces outward during the installation of the replacement insert so that the slotted side is able to cut the threads while the excess material is able to collect within the replacement insert. It is not recommended to use the slotted side with a screw driver because the screw driver tends to break one or both tabs of the slotted side due to the excessive force. If one or both of the tabs are separated from the slotted side by miss-installing the replacement insert with a screw driver, the user loses nearly half of the inside threads of the replacement insert that hold the screw. Also, the thread leads of the slotted side are tapered so that the thread leads are able to gradually remove material. Since the removal of material holds the replacement insert tightly in place within the fairing, pre drilling and usage of epoxy is not required to hold the replacement insert.

Although the invention has been explained in relation to its preferred embodiment, it is to be understood that many other possible modifications and variations can be made without departing from the spirit and scope of the invention as hereinafter claimed.

What is claimed is:

1. A windshield and fairing replacement insert installation tool comprises:
a bolt fastening member;
a spacer sleeve;
a knurled thumb nut;
the bolt fastening member comprises a head section, a shank section, and a threaded section;
the spacer sleeve being rotatably encircled around the shank section;
the knurled thumb nut being threadly engaged with the threaded section; and
the knurled thumb nut being concentrically positioned around the threaded section, adjacent to the spacer sleeve.

2. The windshield and fairing replacement insert installation tool as claimed in claim 1 comprises:
the shank section being concentrically positioned with the head section; and
the threaded section being concentrically positioned with the shank section, opposite of the head section.

3. The windshield and fairing replacement insert installation tool as claimed in claim 1 comprises:
the head section comprises a hub section and at least one pair of handles; and
the at least one pair of handles being radially extended from the hub section.

4. The windshield and fairing replacement insert installation tool as claimed in claim 3 comprises:
the at least one pair of handles comprises a first arm and a second arm; and
the first arm and the second arm being diametrically opposed of each other about the hub section.

5. The windshield and fairing replacement insert installation tool as claimed in claim 1, wherein an outer diameter of the head section is larger than an inner diameter of the spacer sleeve.

6. The windshield and fairing replacement insert installation tool as claimed in claim 1 comprises:
the spacer sleeve being adjacently positioned with a top surface of the knurled thumb nut; and
the threaded section being partially extended from a bottom surface of the knurled thumb nut.

7. The windshield and fairing replacement insert installation tool as claimed in claim 1 comprises:
a flat washer;
the flat washer being concentrically positioned around the shank section; and
the flat washer being rotatably positioned between the spacer sleeve and the head section.

8. The windshield and fairing replacement insert installation tool as claimed in claim 7, wherein a top washer-surface of the flat washer and a top sleeve-surface of the spacer sleeve are positioned parallel with a flat bottom surface of the head section.

9. A windshield and fairing replacement insert installation tool comprises:
a bolt fastening member;
a spacer sleeve;
a knurled thumb nut;
the bolt fastening member comprises a head section, a shank section, and a threaded section;
the shank section being concentrically positioned with the head section;
the threaded section being concentrically positioned with the shank section, opposite of the head section;
the spacer sleeve being rotatably encircled around the shank section;
the knurled thumb nut being threadly engaged with the threaded section; and
the knurled thumb nut being concentrically positioned around the threaded section, adjacent to the spacer sleeve.

10. The windshield and fairing replacement insert installation tool as claimed in claim 9 comprises:
the head section comprises a hub section and at least one pair of handles; and
the at least one pair of handles being radially extended from the hub section.

11. The windshield and fairing replacement insert installation tool as claimed in claim 10 comprises:
the at least one pair of handles comprises a first arm and a second arm; and
the first arm and the second arm being diametrically opposed of each other about the hub section.

12. The windshield and fairing replacement insert installation tool as claimed in claim 9, wherein an outer diameter of the head section is larger than an inner diameter of the spacer sleeve.

13. The windshield and fairing replacement insert installation tool as claimed in claim 9 comprises:
the spacer sleeve being adjacently positioned with a top surface of the knurled thumb nut; and
the threaded section being partially extended from a bottom surface of the knurled thumb nut.

14. The windshield and fairing replacement insert installation tool as claimed in claim 9 comprises:
a flat washer;
the flat washer being concentrically positioned around the shank section; and
the flat washer being rotatably positioned between the spacer sleeve and the head section.

15. The windshield and fairing replacement insert installation tool as claimed in claim 14, wherein a top washer-surface of the flat washer and a top sleeve-surface of the spacer sleeve are positioned parallel with a flat bottom surface of the head section.

16. A windshield and fairing replacement insert installation tool comprises:
a bolt fastening member;
a spacer sleeve;
a knurled thumb nut;
the bolt fastening member comprises a head section, a shank section, and a threaded section;
the head section comprises a hub section and at least one pair of handles;
the shank section being concentrically positioned with the head section;
the threaded section being concentrically positioned with the shank section, opposite of the head section;
the at least one pair of handles being radially extended from the hub section;
the spacer sleeve being rotatably encircled around the shank section;
the knurled thumb nut being threadly engaged with the threaded section; and
the knurled thumb nut being concentrically positioned around the threaded section, adjacent to the spacer sleeve.

17. The windshield and fairing replacement insert installation tool as claimed in claim 16 comprises:
the at least one pair of handles comprises a first arm and a second arm; and
the first arm and the second arm being diametrically opposed of each other about the hub section.

18. The windshield and fairing replacement insert installation tool as claimed in claim 16, wherein an outer diameter of the head section is larger than an inner diameter of the spacer sleeve.

19. The windshield and fairing replacement insert installation tool as claimed in claim 16 comprises:
the spacer sleeve being adjacently positioned with a top surface of the knurled thumb nut; and
the threaded section being partially extended from a bottom surface of the knurled thumb nut.

20. The windshield and fairing replacement insert installation tool as claimed in claim 16 comprises:
a flat washer;
the flat washer being concentrically positioned around the shank section;
the flat washer being rotatably positioned between the spacer sleeve and the head section; and
a top washer-surface of the flat washer and a top sleeve-surface of the spacer sleeve being positioned parallel with a flat bottom surface of the head section.
